(19) United States
(12) Patent Application Publication
(10) Pub. No.: US 2009/0118138 A1
(43) Pub. Date: May 7, 2009

(54) CELL SENSOR HAVING MULTIFUNCTIONAL REACTIONS FOR THE DEFINITION OF QUALITY CRITERIA DURING THE PRODUCTION OF MATERIALS

(75) Inventors: Alexander Walter, Dachau (DE); Udo Leuschner, Regensburg (DE)

Correspondence Address: BLACK LOWE & GRAHAM, PLLC, 701 FIFTH AVENUE, SUITE 4800, SEATTLE, WA, 98104, US

(73) Assignee: GERRESHEIMER WILDEN AG, Regensburg (DE)

(21) Appl. No.: 12/296,073

(22) PCT Filed: Mar. 30, 2007
(86) PCT No.: PCT/EP07/53083

§ 371 Date: Oct. 3, 2008

(30) Foreign Application Priority Data
Apr. 3, 2006 (DE) 10 2006 015 811.3
Sep. 1, 2006 (DE) 10 2006 041 335.0

(51) Int. Cl. C40B 30/06; C40B 50/06; C40B 40/02

(52) U.S. Cl. 506/10; 506/26; 506/14

(57) ABSTRACT

Method for producing a cell sensor system for the definition of quality criteria during the production of materials, characterised by the following method steps:
a) cultivation of first cells of a specific type under standardised culture conditions (control group),
b) cultivation of second cells of the specific type on/in/between different materials to be tested (test group),
c) harvesting of the cells,
d) determination of the gene activities of the cells of the control group and of the cells of the test group,
e) comparison of the gene activities of the test group with the control group,
f) identification of the genes for which there is a difference in the gene activities between the control group and the test group,
g) construction of a microarray using the identified genes with different gene activity as the gene profile, this created microarray being defined as the standard for the specific cell type, and
h) provision of third cells of the specific cell type as cell sensor.

### FIELD OF THE INVENTION

The present invention relates to a method for producing a cell sensor system, to a cell sensor system having multifunctional reactions for the definition of quality criteria during the production and assessment of materials, and to the objective assessment of cell reactions in connection with 3D matrices and other materials.

### BACKGROUND OF THE INVENTION

Three-dimensional (3D) cultures are defined by the fact that the cells in conjunction with a specific spatial environment form structures like those found in tissues and organoid objects.

The reactions of cultivated cells are dependent on the cell type, on the surrounding culture medium and on the material of the culture chamber used. In the simplest case, cells are cultivated for this purpose on the bottom of a culture dish or together with a natural or artificial 3D matrix (biomaterial). Depending on the culture strategy, the cells grow on flat surfaces or materials having cavities of a greater or lesser size. Depending on the material used, the cells may exhibit very different reactions.

Cells in conjunction with a 3D matrix exhibit complex reactions which are unpredictable. Upon contact with a 3D matrix, the cells first attach themselves loosely (adhesion), form specific cell anchors during the attachment process (adherence) and in the optimal case remain attached for relatively long periods of time in a more or less close interaction (affinity). Due to the specific spatial environment, very different cell-biological reactions can be observed in the cells. The spectrum extends from cell division (mitosis), overgrowing of the 3D matrix (spreading) to the formation of typical (differentiation) but also atypical (dedifferentiation) tissue structures. The cultures moreover cannot survive for arbitrarily long periods of time. In this connection, therefore, processes for apoptosis, necrosis and degeneration are also important cell-biological processes.

The different stages of the cell/tissue culture are characterised as follows:

Adhesion and adherence: After an adhesion, that is to say a brief primary contact of cells on a 3D matrix, a decision is made as to whether a longer contact is to take place. This formation of provisional anchor structures is known as adherence. However, the fact that cells remain on a 3D matrix does not make it possible to state specifically whether, for how long and how firmly the cultivated cells will remain attached and what tissue-specific properties will be formed in the process. Good adherence is imparted not solely by the cell and not solely by the 3D matrix used in each case but rather is possible only in the event of a close cooperation between both the entities involved: The following processes take place.

Adherence: In order to form contact with a 3D matrix, specific integrins are formed as anchors by the cell for example. In order that adherence can take place, therefore, receptors for the anchors of the cells must be present in the 3D matrix. With regard to the natural extracellular matrix (ECM), in most cases the amino acid sequence of the receptors for the integrins is known. However, for the polymer materials of the various culture articles that are used, it is not known how the receptors for the respective integrin anchors of the different cell types are constructed. Amino acid sequences are usually not contained in the polymers (such as e.g. culture dishes made from polystyrene). Therefore, very different molecule configurations have to imitate the presence of a receptor for integrins in the polymers.

### (Valenick L V et al., Experimental Cell Research 309: 48-55, 2005)

Affinity: When cells decide to definitively remain on a material and then develop typical properties, this process is significantly influenced by the material used and its surface condition. This process is controlled by the fact that the cells are connected interactively to a 3D matrix via integrin anchors for example. In the case of 3D cultures, therefore, 3D matrices which are as optimised as possible are used so as to strive to imitate experimentally the natural forms of interaction. It is therefore in one's own interest to use 3D matrices with a high affinity for the respective cells. It can be assumed that only such 3D matrices also aid an optimal spatial and functional development of the maturing tissue structures.

### (Kofidis et al., Medical Engineering & Physics 26: 157-163, 2004)

Mitosis: Cell divisions serve on the one hand to obtain cells and on the other hand to ensure that a sufficiently large mass of tissue can form from a small number of cells. When using matrices for the 3D culture, a decision must therefore be made as to whether the sought matrix also actually aids cell divisions. Using molecular-biological and immunological markers, such as for example for cell cycle-specific proteins (cyclins or cyclin-dependent kinases), it can be shown how many cells are in the mitosis phase and in contact with a 3D matrix. The respective result conversely shows the extent to which the 3D matrix used is promoting or inhibiting the multiplication of cells.

Lots of data show that the mitosis behaviour in the organism is controlled in a specific manner up to the level of the tissue found therein and subpopulations of cells. For example, in the small intestine, the epithelial cells of the villi have a very high regeneration rate, whereas the enterochromaffin cells and Paneth's granular cells in the immediately adjacent crypts exhibit a very much lower mitosis activity. Here, a decision is made at an individual cell boundary that the epithelium of the villi will be regenerated within two to three days, whereas in the crypts no divisions will be observed for many months. Such cell-biological differences are also found in the case of connective tissue cells. Chondroblasts (cartilage) and osteoblasts (bone) for example exhibit amazingly high cell division rates, whereas, after the formation of an extracellular solid substance, chondrocytes and osteocytes no longer exhibit any cell division (or exhibit no cell division for relatively long periods of time).

### (Gruber et al., Musculoskeletal Disorders 1: 1, 2000)

Spreading: Experience shows that many cells can multiply without any problem when they adhere to the smooth bottom of a culture dish. However, if the cells are provided with a 3D matrix having a different roughness content, other complex cell reactions can be seen in addition to mitosis. The possible spectrum extends from the complete growing of the cells into the smallest corners of each roughness to the rounding of all the cells and thus to the complete rejection of the surface of the material used. If a 3D matrix which is attractive to the cells is used, it can already be seen after a relatively short period of time that the entire surface and the available interior spaces are populated with cells. Moreover, the cells grow onto one another in different layers. This massive propagation of cells keen to divide is known as “spreading”. However, the cells which now appear all over the place exhibit very different functional states. The spectrum extends from different stages of mitosis to the typical interphase with firm contact of the cells to one another and to the provided 3D matrix.

It is noteworthy that the cells during spreading are in constant contact with the respective 3D matrix throughout the entire mitosis phase, cytokinesis and the interphase, and do not detach. This process is presumably controlled via the ERK kinases (extracellular signal regulated kinases) and MAP kinases (mitogen activated protein kinases).

### (Vouret-Craviari V et al., J Cell Science 117: 4559-4569, 2004)

Differentiation: From individual cells, there should be obtained in the course of the culture process communicating cell aggregates and, from these, functional tissue structures. This process of differentiation does not proceed automatically but rather is controlled by a large number of different factors. These include inter alia morphogens, growth factors, hormones, nutrient media and above all a suitable 3D matrix. With the exception of the 3D matrix, each of these factors acts in a more or less narrow time window. If individual factors do not occur or do not occur to a sufficient extent, this results in a shift in the differentiation profile. As a result, it is not typical properties that are formed but rather varying degrees of atypical properties.

### (Batorsky et al., Biotechn Bioeng 92: 492-500, 2005)

In addition to the culture medium, the extent of the molecular interaction of cells also depends greatly on the material of the 3D matrix and thus on its surface condition. Adhesion, adherence and affinity are processes which are hugely influenced by the matrix of the cell growth vessel. For example, the growth of cells on glass, polymethyl methacrylate (pMMA), polyethylene (PE), polystyrene (PS) and polycarbonate (PC) is very different. Here, the adhesion and affinity for the cells can often be improved through a modification of the surface charge, such as a plasma treatment for example. The division behaviour of cells can also be influenced, for example by a 3D matrix. Too low a porosity for example can inhibit mitosis activity, whereas larger pores can aid the division of cells. Excessively large cavities may in turn mean that the division of cells is not further promoted. It is not known which biophysical influences ultimately affect this different behaviour of cells. Therefore, it is very difficult to design culture matrices and to choose the correct materials. It is not possible to predict the suitability of a material. It is entirely unclear why cells can settle on 3D matrices even though these have no molecular similarity to the natural extracellular matrix. Probably a whole series of different physicochemical surface parameters influence the adherence, adhesion, affinity, mitosis, spreading and differentiation of cells. Experiments regarding the population of cells on 3D matrices show that there is no single material which would be equally highly suitable for all purposes. Instead, it has been found that each cell type has very specific requirements and therefore a 3D matrix has to be selected and adapted in a very individual manner. For instance, a matrix which is optimally suitable for liver parenchyma cells need not automatically be the first choice also for insulin-producing cells. For connective tissue cells, such a matrix is even very likely to be completely unsuitable.

From what has been stated above, it can be seen how important the material is for growth. When newly developing a 3D matrix, its suitability cannot be predicted. Therefore, for each new development, new experiments always have to be carried out in order to discover the actual suitability. However, there are no objective criteria for assessing the material, especially a 3D matrix. Depending on the 3D matrix provided, the cells may react very sensitively on the one hand with desired differentiation and on the other hand with undesired dedifferentiation. A major unsolved problem in this connection is the fact that cells, when populating a 3D matrix with good affinity, do not automatically develop all the functional properties of a tissue, but rather may remain in a sometimes more, sometimes less immature intermediate state of differentiation.

From experience, it is known how long a cell line or a primary culture requires in order to form a confluent cell layer on the surface of a culture dish made from polystyrene. If, for example, part of the dish bottom is coated with an unsuitable polymer, such as poly(2-hydroxyethyl methacrylate) for example, the number of adhering cells decreases drastically. A confluent monolayer of cells then no longer forms. The example shows how sensitively cells can react when they meet a new surface.

There are numerous methods for analysing the suitability of a two-dimensional material, such as the bottom of a culture dish; however, these methods are very limited in the case of 3D matrices. Although it is possible, based on the adhesion behaviour of cells and using optical methods, to ascertain very quickly how well or how badly the cells will accept the surface of a 3D biomatrix that is used, this is nevertheless only a vague estimate since, on its own, the growth behaviour and the number of cells does not provide any further information regarding the cell-biological quality of anchoring to a 3D matrix. Moreover, no statements can be made about the depth of a 3D matrix. The reactions of cells in contact with a 3D matrix have to date always been recorded in a very vague manner. This includes for example the determination of the number of cells, the vitality, the detection of individual proteins with an antibody or the formation of a secreted molecule. Furthermore, hardly anything has been stated regarding what otherwise happens with regard to molecular functions in the respective cell population in three-dimensional space.

While the functional profile and thus also the differentiation profile of two-dimensional cultures can be examined in a very satisfactory manner using analysis methods known to date, completely new techniques have to be used for three-dimensional cultures. The reason for this is that the cells in a 3D matrix are no longer discernible morphologically for example due to the layer thickness and can no longer be reached for physiological deductions. By contrast, direct access to the cells is possible in the case of two-dimensional cultures. For this reason, completely different analysis methods have to be used for three-dimensional cultures, which methods precisely reflect the many complex reactions of cells in the interior of a 3D matrix.

To date, it is not possible to ascertain the suitability of a material as a culture chamber, in particular a 3D matrix material, based on a large number of objective parameters within a reasonable period of time.

The object of the present invention is therefore to provide a method for producing a sensor system, by means of which it is possible to detect a broad spectrum of complex cell-biological reactions in connection with a material.

Another object of the present invention is to provide a sensor system for detecting the complex cell reactions, which for the first time allows an objective assessment of cell reactions in connection with 3D matrices and other materials.

Another object of the invention is to provide a method for assessing materials.

These objects are achieved by the method defined in claim 1 for producing a cell sensor system, the cell sensor system defined in claim 16 and the method defined in claim 22 for assessing materials.

Advantageous further developments of the invention form the subject matter of the dependent claims and will be explained in more detail in the description.

### DESCRIPTION OF THE INVENTION

The method according to the invention for producing a cell sensor system is characterised by the following method steps:
a) cultivation of first cells of a specific type under standardised culture conditions (control group),
b) cultivation of second cells of the specific type on/in/between different materials to be tested (test group),
c) harvesting of the cells,
d) determination of the gene activities of the cells of the control group and of the cells of the test group,
e) comparison of the gene activities of the test group with the control group,
f) identification of the genes for which there is a difference in the gene activities between the control group and the test group,
g) construction of a microarray using the identified genes with different gene activity as the gene profile, this created microarray being defined as the standard for the specific cell type, and
h) provision of third cells of the specific cell type as cell sensor and of the microarray standard constructed in step g).

The method is suitable in particular for assessing the quality of materials, and also for the definition of quality criteria during the production of materials.

All known cells and also cell lines may be used. The cells include the cells of the basic tissue (epithelium, muscle, nerve tissue (neurons), connective tissue) and of the haematopoietic system of the healthy and sick animal and human organism, stem cells, embryonal and adult tissue, and also the cell lines derived therefrom, of the healthy and sick animal and human organism. Plant cells and cell lines may also be used.

In connection with the method according to the invention, “standardised culture conditions” are understood to mean culture conditions under which the respective cell types are customarily cultivated. These are known to the person skilled in the art, see for example also W. W. Minuth, R. Strehl, K. Schumacher (2005) Tissue Engineering—Essential for Daily Laboratory Work. WILEY-VCH Verlag, ISBN 3527311866. However, in the context of the invention, “standardised conditions” may also mean culture conditions under which the cells cultivated on a standard culture surface are excited by various stimuli for differentiation which are known to the person skilled in the art.

Furthermore, “harvesting of the cells” is understood to mean the workup of the cells for the subsequent determination of the gene activities. The workup depends on the level at which the gene activities are to be determined. Advantageously, the gene activities are determined at the nucleic acid level and/or at the protein level. The corresponding workup methods, i.e. the isolation of RNA and/or protein, are known to the person skilled in the art (e.g. Sambrook et al., Molecular Cloning: A Laboratory Manual, Cold Spring Harbor Laboratory Press, 3rd edition).

In connection with the present invention, the expression “determination of gene activities” refers to analyses of the differential gene expression, i.e. the expression of various genes is analysed and the expression pattern is determined. “Gene expression” refers to the entire process of converting the information contained in the gene into a protein. In one advantageous embodiment of the invention, the gene expression patterns are determined by using microarrays. A distinction is made between two types of microarrays: on the one hand DNA microarrays and on the other hand protein microarrays. The choice of microarray depends on the level at which the gene activities are to be determined. If the gene activities are determined at the nucleic acid level, a DNA microarray is used. There are two different types of DNA microarray: on the one hand those based on bound cDNA and those based on synthetically produced oligonucleotides. These serve as probes which are applied at defined positions of a grid, e.g. on glass supports. Regardless of the type of array used, RNA is firstly extracted from the cells to be analysed and this is transcribed after any purification and/or multiplication steps of the mRNA into cDNA or cRNA and is labelled for example with fluorescent dyes, chemiluminescent labels, luminescent labels and electronic labels. These are then hybridised with the DNA microarrays. In the process, labelled cDNA/cRNA fractions bind to their complementary counterpart on the array. After washing off the non-bound cDNA/cRNA fractions, the fluorescence signal of each position of the microarray is read by means of a laser, or corresponding detection methods known to the person skilled in the art are used if using other labels. This pure intensity is usually normalised in order to take account of degradation effects, extractions of varying success and other effects. For oligomer-based microarrays, currently two widely known normalisation methods are used, either RMA (Robust Multiarray Analysis) or GCOS/MAS from the company Affymetrix. The normalised results are then evaluated and visualised. For this, too, a number of bioinformational tools are available, for example Genesis for data analysis and visualisation. Furthermore, with the Bioconductor project, a large library of tools is available for data analysis under GNU_R. It is also possible to use the system from the company Applied Biosystems, which combines chemoluminescence with fluorescence and in which no ESTs are spotted but rather 60-mer oligos.

If gene expression is to be determined at the protein level, protein microarrays are used and thus proteins are isolated from the cells. Protein samples are then applied to the array. Any spots in which no interaction takes place remain empty after a washing step has been carried out. The detection method then makes it possible to distinguish between spots with and without protein-protein interaction. Quantitative detection methods are also possible, in which the quantity of adhering protein can be determined.

There are various types of protein microarrays, which differ according to the type of interaction (antigen-antibody, enzyme-substrate, receptor-protein or general protein-protein interaction). It is also possible to differentiate whether proteins of the sample are fixed to the array and then tested with a plurality of specific, known test proteins or whether the test proteins are fixed in the test areas and then the reaction with the sample proteins takes place.

The Western Method microarray serves for detecting antigens in the cell lysates of various tissues or in protein fractions obtained by isoelectric focusing. The cell lysate or protein fraction is spotted onto the carrier material of the microarray, and thereafter the antibody is applied. The antibody adheres in each test field with antibody-antigen interaction. Fields containing antibody are then detected in the same way as in Western blot.

Antibody microarrays: The antibodies are fixed (spotted) and then the sample is applied to the array.

Antigen microarrays: A different antigen is fixed on each test area of the array. If the sample contains the associated, specific antibody, this adheres to the test area. The reaction can thus be tested simultaneously on a large number of antigens or allergens.

In the case of protein domain microarrays, fusion proteins are fixed on the array in order to detect protein-protein interactions. The fusion protein allows the reliable fixing on the array with the first part, without disrupting the interaction capability of the other protein part. The applied protein adheres only to those test areas at which an interaction takes place.

One possible advantage compared to DNA microarrays is the more rapid in situ analysis of samples, since it is possible to omit the often necessary amplification of genetic material and also the hybridisation.

Preferably, whole genome microarrays are used for step d) of the method. It is also possible to use microarrays which can be used to search within a relatively wide or narrow spectrum in a targeted manner for individual functions or groups of functions of the cell. Such groups of functions include functions such as, for example, cell cycle, reactions on the cell nucleus, binding of the cell to surfaces, cell stress, formation of the typical cytoskeleton, signal transduction and/or apoptosis. Depending on the microarray used, a large number of groups of active or inactive genes and proteins can thus be identified, the functions of which are known in the presently examined context. Added to this, however, is the analysis using many groups of genes and proteins which have not yet been surmised in this connection. Depending on the up-regulation or down-regulation of gene activity or protein synthesis for a tested material, individual gene activities or protein activities can prove to be material-specific.

In this way, it is possible for the first time to detect objectively a broad spectrum of complex cell-biological reactions of cells in connection with a material:
1. In the positive case of a material test, the histiotypic differentiation profile can thus be detected.
2. In the negative case, an atypical development such as a dedifferentiation can thus be determined.
3. A modified material can be classified between these two extremes and can be further optimised if necessary.

Since the surface of the materials used, such as for example the bottom of a culture dish made from polystyrene, does not possess the information sequences like the natural ECM, gene profiles for individual cell types under culture conditions can be worked out for the first time using the microarray technique and can be compared with a suitable control. It is possible in this case to objectively ascertain which materials cause typical reactions and which cause atypical reactions in the cells. In this connection, it is possible to read not only individual properties but rather a whole cell-biological spectrum of reactions which extends from unsuitable, less suitable to suboptimal and optimal.

With regard to the different groups of functions, preferably the following microarrays are selected:

Cell cycle microarrays are configured in such a way that it is possible to determine the expression profiles of genes which are involved in the control of cell growth and division and can be found in the customary databases known to the person skilled in the art, such as e.g. the Mouse Genome Informatics: http://www.informatics.jax.org, or in the following databases: wwwgenecards.org; gdb.org. Preferably determined are the expression profiles of the genes which encode e.g. cyclins and their associated cyclin-dependent kinases (CDKs), CDK inhibitors, CDK phosphatases and cell cycle checkpoint molecules, which are involved in the control of cell growth and division.

Signal transduction microarrays are such that it is possible to determine the expression profiles of genes which control cell processes through extracellular ligands, ligand receptors and intracellular signal modulators. These can be found in the customary databases, such as e.g. the Mouse Genome Informatics: http://www.informatics.jax.org, or in the following databases: wwwgenecards.org; gdb.org. These may preferably be selected from the group comprising: Ca²⁺/NFAT signal pathways, cAMP/Ca²⁺ signal pathways, DNA damage signal pathways, EGF/PDGF signal pathways, hypoxia signal pathways, G proteins and signal molecules, glucocorticoid signals, G protein-coupled receptors, growth factors, immunological signal pathways, insulin signal pathways, JAK/STAT signal pathways, MAP kinase signal pathways, NF_{K}B signal pathways, nitrite oxide, Notch signal pathways, nuclear receptors and co-regulators, p53 signal pathways, PI3K-AKT signal pathways, TGFβ BMP signal pathways, Toll-like receptor signal pathways, Wnt signal pathways.

Apoptosis microarrays are configured in such a way that it is possible to determine the expression profiles of genes which encode key ligands, receptors, intracellular modulators and transcription factors, which are involved in the regulation of programmed cell death. These can be found in the customary databases known to the person skilled in the art, such as e.g. the Mouse Genome Informatics: http://www.informatics.jax.org, or in the following databases: wwwgenecards.org; gdb.org.

The microarrays of the other groups of functions—reactions on the cell cycle, binding of the cell to surfaces, cell stress, formation of the typical cytoskeleton—accordingly comprise the expression profiles of genes which are involved in the corresponding group of functions. These can be found in the customary databases known to the person skilled in the art, such as e.g. the Mouse Genome Informatics: http://www.informatics.jax.org, or in the following databases: wwwgenecards.org; gdb.org.

In one preferred embodiment of the invention, only those genes are identified for which there is a difference in expression by at least a factor of two. In a more preferred embodiment, the factor of the difference in expression is at least three.

One preferred further development of the invention provides for the standard microarray the following genes when the determined cells are e.g. 3T3-L1 fibroblasts: pyruvate carboxylase, stearoyl-coenzyme A desaturase 1, fatty acid binding protein 5, glycerol-3-phosphate dehydrogenase 1, apolipoprotein D, fatty acid binding protein 4, apolipoprotein C-1, adipsin, lipin 1, adinectin, lipase, angiotensinogen, resistin, CD36 antigen, fibromodulin, procollagen-lysine 2-oxoglutarate 5-dioxygenase 1, tissue inhibitor of metalloproteinase 4, lumican and clusterin.

The materials to be tested are long-chain organic molecules, standard polymer materials and biodegradable materials. Preferably, the materials to be tested are 3D matrix materials. Preferably, in a further embodiment, a tested 3D matrix material is provided in step h) of the method according to claim 1 together with the cells of the specific cell type as cell sensor and the microarray standard constructed in step g) is provided as part of the cell sensor system. This 3D matrix material is preferably a material which aids the differentiation of the cells of the specific type and can thus act as a “golden standard”. The 3D matrix material is preferably polystyrene foamed with CO₂. This material may be used e.g. as the “golden standard” in connection with 3T3-L1 fibroblasts and the standard microarray defined above for this.

The above comments and definitions regarding the method according to the invention also apply in connection with the following further aspects of the invention, in particular the cell sensor system, the method for assessing materials, the use of cells for assessing the quality of materials, the use of microarrays for producing a standard for use in a cell sensor system, and also the kit according to the invention.

In addition to the previously described method, the invention relates to a cell sensor system having multifunctional reactions for the definition of quality criteria during the production of materials and for assessing the quality of materials, which consists of cells and the standard microarray(s) created for the specific cell type according to the method. In one preferred embodiment, the standard microarrays are DNA arrays and/or protein arrays.

Preferably, the cell sensor system comprises a tested 3D matrix. This 3D matrix usually consists of long-chain organic molecules, standard polymer materials and biodegradable materials. The 3D matrix, which forms part of the cell sensor system, is preferably a 3D matrix which aids the differentiation of the cells of the specific type and can thus act as a “golden standard”. The 3D matrix material is preferably polystyrene foamed with CO₂. This material may be used e.g. as the “golden standard” in connection with 3T3-L1 fibroblasts and the standard microarray defined above for this.

When a cell enters into contact with a 3D matrix, it sensitively detects signals from its surroundings. This triggers and/or aids the adhesion, adherence, affinity, mitosis, spreading but also the differentiation of the cells. These signals have to pass from the outside of the cell via the plasma membranes into the interior of the cell. This involves inter alia the ERK system which influences the varied processes for nucleotide synthesis, gene expression and protein synthesis which are subsequently then controlled by the MAP kinases. One of these key enzymes for DNA or RNA synthesis is for example carbamyl phosphate synthase II (CPS II). Incubations of cultures with epidermal growth factor have shown for example that the ERK/MAP kinases transfer phosphate groups to CPS II. This phosphorylation can be accelerated by PRPP (phosphoribosyl phosphate), which leads to an increased nucleotide synthesis (DNA) and thus to an increased transcription activity (protein synthesis). The signal from the cellular MAP kinases leads to an increase in gene expression by activating the rapid response gene within minutes. This in turn takes place via an activation of transcription factors and the phosphorylation of histone proteins. This therefore leads to a change in configuration on the histone molecules, as a result of which the DNA is activated for mRNA formation and thus further protein formation.

The mitosis of cells mediated via ERK/MAP kinases is controlled via the CDK (cyclin-dependent protein kinase) family. The cyclin D1 protein and its partner Cdk4 are activated, as a result of which a complex forms. If this complex is phosphorylated, the mitosis inhibition in the cell can be lifted. This in turn releases the transcription factor E2F, which leads to a rise in the transcription of genes which aid mitosis and spreading via DNA replication.

Based on this example, it can be seen that extracellular signals can have significant influences on mitosis and many other important cell-biological functions in the interior of cells. These include, in addition to signals from morphogens and growth factors, the osmolarity of the culture medium, the stress caused by the flowing of a fluid or by hydrostatic pressure, and finally also the surface and the interior of a 3D matrix.

When cells are to be optimally developed in connection with a 3D matrix, very specific properties of the growth surface and of the interior are then required since ultimately only they offer an optimal affinity and chances for further development of the cell. These processes are mediated via cell anchors (e.g. integrins), which forward information into the cell interior.

Besides integrins, matricellular proteins such as thrombospondin or SPARC (osteonectin) for example also have a further important significance for producing and maintaining cell functions. On the one hand, they can modulate the production of proteins of the extracellular matrix and on the other hand they have an influence on the effectiveness of growth factors by forming additional receptors. However, this very multilayered regulation mechanism can be obtained only if the cell detects a suitable anchoring on the provided 3D matrix. Only this allows the triggering of other varied cell-biological functions via extracellular and cellular signal cascades.

These reactions of cells can be put to technical use. Cells can thus be used as highly sensitive sensors. The very complex cell-biological reactions can be analysed and displayed by means of a standard microarray. Using this cell sensor system, it is then possible to analyse materials. For this, use is made of a control and a material to be tested, such as for example a modification of polystyrene which has been used to produce an improved culture dish. In order to test this material, a defined cell population is cultivated in a defined culture medium for a defined period of time. The quality of the material to be tested is ascertained via the cell-biological reactions of the cells, which are incubated in conjunction with the respective material. Here, the cells act as a sensor on the respective material and indicate a band spectrum between a positive and negative development.

The signal of the cell sensor is multilayered, and therefore even individual experimental derivations of the cell say nothing about its actual current overall status.

For this reason, as far as possible all possible gene reactions and protein expressions must be detected. This is possible via the microarray technique. The chips used are composed of a large number of information channels and thus represent simultaneously a transducer and amplifier function of the cell-biological functional changes of the cells. With the aid of suitable scanner technology and software, the extent of gene activity and protein activity at the time of measurement is finally determined. From step to step of a planned material modification, it is possible to check using the preset cell sensor whether the same or completely different groups of genes are being up-regulated or down-regulated. Analogously, it is also possible to analyse with each material modification which genes or proteins are active to an increased or reduced extent, or which are formed. For the first time, therefore, the phases of adhesion, adherence, affinity, spreading and differentiation can be objectively analytically detected. Moreover, the data can for the first time be compiled in the corresponding time windows of the procedures outlined above. This means that a material covered in cells may have very different properties at the start, in the middle and at the end of an experiment. The reason for this is that the cells produce extracellular matrix depending on the material used and thus change the surface of the material in the positive or negative sense. In this way, using a protein chip for example, it is possible to seek out material properties which stimulate the cells to form extracellular matrix proteins.

Chip technology forms the possibility that many thousands of genes and hundreds of proteins can be tested simultaneously using a single cell sample. As a result, genes and proteins are being discovered which had not been thought of or considered relevant in this connection. Thus, for each cell type, a specific standard must be defined by the method according to the invention. Based on this standard, improved or poorer materials can be reliably detected and evaluated without subjective influences. Moreover, risks of any biomaterials can be detected objectively for the first time using the microarray technique. It is thus possible for the first time to define in molecular biology terms the extent of the interaction of cells in connection with a biomaterial. Using the presented cell sensor system, it will be possible to objectively assess the culture of cells on any materials. This can be used as a critical advantage by the manufacturers of culture articles:
1. This applies to the modification of materials used to date.
2. This applies to the new development of materials.
3. This applies to ensuring the quality of individual batches.
4. This applies to the certification of products using microarray data.
5. This applies to the identification of fake products.

The following cells and cell lines are used with preference as cell sensors in the cell sensor system according to the invention: The cells of the basic tissue (epithelium, muscle, nerve tissue (neurons), connective tissue) and of the haematopoietic system of the healthy and sick animal and human organism, stem cells, embryonal and adult tissue, and also the cell lines derived therefrom, of the healthy and sick animal and human organism. Plant cells and cell lines may also be used. Said cells and cell lines are also used in the other aspects of the invention, such as e.g. the method for producing a cell sensor system, the method for assessing materials, the use of cells, and also the kit.

One preferred further development of the invention provides 3T3-L1 fibroblasts as the cell sensor.

If cell lines are used when testing 3D matrices, account must additionally be taken of the fact that, with each experiment, a selection of the cells having the best affinity properties can be achieved. If always only those cells which exhibit a strong affinity for the respective 3D matrix are used for the subcultivation, cells which adhere better are produced as a result of the selection pressure. In this case, however, all the cells from this population which do not have such good adhesion properties are lost. It is thus possible to obtain for example cell clones which exhibit an increasingly better affinity for a 3D matrix. However, this effect is not desirable for the objective testing of materials. Therefore, the experiments must always be carried out with cells of the same original identity.

In an even more specific embodiment, the microarray of the cell sensor system according to the invention contains the following gene profile: pyruvate carboxylase, stearoyl-coenzyme A desaturase 1, fatty acid binding protein 5, glycerol-3-phosphate dehydrogenase 1, apolipoprotein D, fatty acid binding protein 4, apolipoprotein C-1, adipsin, lipin 1, adinectin, lipase, angiotensinogen, resistin, CD36 antigen, fibromodulin, procollagen-lysine 2-oxoglutarate 5-dioxygenase 1, tissue inhibitor of metalloproteinase 4, lumican and clusterin.

In a further aspect, the invention provides a method for assessing materials, which is characterised by the following method steps:
a) cultivation of first cells of a specific type under standardised culture conditions (control group),
b) cultivation of second cells of the specific type on/in/between different materials to be tested (test group),
c) harvesting of the cells,
d) determination of the gene activities,
e) comparison of the gene activities of the test group with the control group,
f) identification of the genes for which there is a difference in the gene activities between the control group and the test group,
g) construction of a microarray using the identified genes with different gene activity as the gene profile, this created microarray being defined as the standard for the specific cell type, and
h) cultivation of third cells of the specific cell type under standardised culture conditions (control group),
i) cultivation of fourth cells of the specific type on different materials to be tested (test group),
j) harvesting of the cells,
k) determination of the gene activities of the cells of the control group and of the cells of the test group using the standard microarray.

According to the invention, the method has been further developed such that only steps h-k are carried out.

In one advantageous embodiment, the cultivation of cells as the control group in step h) of the method according to the invention takes place on a 3D material which has already been tested. Preferably, this 3D matrix aids the differentiation of the cells of the specific type and can thus be defined as the “golden standard”.

According to the invention, the cell sensor system according to the invention is used in the method for assessing materials.

In yet another aspect, the invention provides the use of cells for assessing the quality of materials based on the cell-biological reactions of the cells. Preferably, the cells and cell lines already mentioned above are used.

In another aspect, the invention relates to the use of microarrays for producing a standard for use in a cell sensor system.

In yet another aspect, the invention provides a kit which comprises the cell sensor system according to the invention, medium and one or more 3D matrices.

The invention will be explained in more detail below on the basis of an example of embodiment and without limiting the general concept of the invention.

### EXAMPLE

3T3-L1 cell sensor system—3T3-L1 cell sensor having multifunctional reactions for the definition of quality criteria during the production of materials and for assessing the quality of materials.

The suitability of a 3D matrix for cultivating high-quality cells with a natural gene expression pattern can be analysed with the aid of microarrays. Depending on the cell type and the culture conditions used, different gene expression patterns may be observed. In this example of embodiment, the creation of a cell sensor system based on 3T3-L1 fibroblasts is shown. These cells were used to validate an open-pore foam structure made from polystyrene. This cell line is a precursor of fat cells. The cells can develop to form fat cells through the addition of suitable differentiation media. The cells were cultivated in the 3D structure and as a control group in standard cell culture dishes. After a culture time of 1, 3 and 5 weeks, the cells were lysed and the RNA contained in the cells was isolated. Starting from this RNA, microarrays were produced in order to validate the degree of differentiation and thus the quality of the cells on the substrate to be tested. Overall, 22690 genes were able to be tested in this way. In order to evaluate the microarrays, 2 different programs were used: RMA (Robust Multiarray Analysis) and a program from the manufacturer Affymetrix (GCOS 1.2 software). Only the genes for which both programs showed positive or negative differences in expression were further analysed. The only genes of interest were those for which a change by at least the factor 3 took place, namely when compared using the Affymetrix software and using the RMA software.

### Material and Methods:

Total RNA was isolated for the further microarray analysis using an oligonucleotide GeneChip® Mouse Genome 430A 2.0 Array (Affymetrix) according to the manufacturer's instructions. In brief, 5 μg of total RNA was used in order to synthesise biotin-labelled cRNA, and 10 μg of fragmented cRNA were hybridised with the GeneChips for 16 hours at 45° C. The GeneChips were washed, labelled as recommended and scanned using the GeneArray scanner, controlled by the Affymetrix GCOS 1.2 software. The raw gene expression data were processed and normalised using a) the Affymetrix GCOS 1.2 software module according to the manufacturer's instructions and b) by Robust Multiarray Analysis (RMA) (Irizarry, 2003#3).

Genes which reproducibly exhibited a greater than 1.3-times regulation were used for the further analysis.

### Results:

The fat metabolism genes which showed differences in expression are summarised in Table 1, and the genes of the extracellular matrix (ECM) are summarised in Table 2.

TABLE 1
Most important factors in fat metabolism which
exhibit differences in expression

| Gene | Abbreviation | Function |
|---|---|---|
| Pyruvate | Pcx | Fatty acid synthesis |
| carboxylase | | |
| Stearoyl-coenzyme A | Scd1 | Occurs in later |
| desaturase 1 | | differentiation phase, |
| | | function in triglyceride |
| | | metabolism |
| Fatty acid binding | Fabp5 | Transport |
| protein 5 | | |
| Glycerol-3- | Gpd1 | Occurs in later |
| phosphate | | differentiation phase, |
| dehydrogenase 1 | | function in triglyceride |
| | | metabolism |
| Apolipoprotein D | Apod | Transport |
| Fatty acid binding | Fabp4 | Transport |
| protein 4 | | |
| Apolipoprotein C-1 | Apoc1 | Lipid transport |
| Adipsin | Adn | Protein secreted by |
| | | adipocytes |
| Lipin 1 | Lpin1 | Lipid metabolism |
| Adiponectin | Adipoq | Signal molecule secreted |
| | | exclusively by |
| | | adipocytes, function in |
| | | lipid metabolism |
| Lipase | Lipe | Lipid metabolism |
| Angiotensinogen | Agt | Protein secreted by |
| | | adipocytes |
| Resistin | Retn | Signal molecule secreted |
| | | by adipocytes and having |
| | | a controversial function |
| CD36 antigen | Cd36 | Occurs in later |
| | | differentiation phase, |
| | | fatty acid transporter |

TABLE 2
Most important factors of the ECM which exhibit
differences in expression

| Gene | Abbreviation | Function |
|---|---|---|
| Fibromodulin | Fmod | Proteoglycan, component |
| | | of ECM, binds collagen |
| | | fibrils |
| Procollagen-lysine, | Plod1 | Influence on collagen |
| 2-oxoglutarate 5- | | stability |
| dioxygenase 1 | | |
| Tissue inhibitor of | Timp4 | Inhibitor of collagen |
| metalloproteinase 4 | | degradation |
| Lumican | Lum | Proteoglycan, component |
| | | of ECM |
| Clusterin | Clu | Glycoprotein, component |
| | | of ECM |

Starting from this first filtering, a microarray specifically designed for this cell type can be produced which contains only the relevant genes.

A few comparative groups are shown below by way of example:

1. A comparison was carried out of the gene expression pattern of non-induced cells after a culture period of 5 weeks on standard culture surfaces (2D) and in a 3D matrix (3D). The cells cultivated in the 3D matrix show increased expression levels in the case of fat-typical genes such as adipsin or lipin 1, which makes it possible to conclude an increased differentiation in the 3D structure.

| Induced | Surface | Time |
|---|---|---|
| no | 2D [symbol] 3D | 5 weeks |

| Gene symbol | Gene name | Fold Change RMA |
|---|---|---|
| Fmod | fibromodulin | 7.41880099 |
| Scd1 | stearoyl-coenzyme A | 6.75264622 |
| | desaturase 1 | |
| Scd1 | stearoyl-coenzyme A | 6.73976255 |
| | desaturase 1 | |
| Pcx | pyruvate carboxylase | 3.7015062 |
| Fabp4 | fatty acid binding protein | 7.1741056 |
| | 4, adipocyte | |
| Apoc1 | apolipoprotein C-1 | 4.32503396 |
| Adn | adipsin | 20.2100308 |
| Lpin1 | lipin 1 | 4.73274873 |
| Fabp4 | fatty acid binding protein | 5.9418088 |
| | 4, adipocyte | |
| Fabp4 | fatty acid binding protein | 5.49877767 |
| | 4, adipocyte | |
| Fmod | fibromodulin | 4.71459538 |
| Fmod | fibromodulin | 3.65339497 |
| Retn | resistin | 11.1491854 |
| Cd36 | CD36 antigen | 33.8000785 |
| Cd36 | CD36 antigen | 4.01193924 |
| Fabp4 | fatty acid binding protein | 7.09433811 |
| | 4, adipocyte | |
| Fmod | fibromodulin | 17.4081919 |

2. In order to verify the results from 1., the cells cultivated on the standard culture surface (2D) were excited by a hormonal stimulus for differentiation to fat cells. The genes expressed in the differentiated cells largely coincide with the expressed genes of the cells cultivated in the 3D culture.

| Induced | Surface | Time |
|---|---|---|
| yes [symbol] no | 2D | 3 weeks |

| Gene symbol | Gene name | Fold Change RMA |
|---|---|---|
| Pcx | pyruvate carboxylase | 3.60800586 |
| Scd1 | stearoyl-coenzyme A | 26.6933954 |
| | desaturase 1 | |
| Scd1 | stearoyl-coenzyme A | 36.9262059 |
| | desaturase 1 | |
| Fabp5 | fatty acid binding protein | 3.22117879 |
| | 5, epidermal | |
| Gpd1 | glycerol-3-phosphate | 7.91468237 |
| | dehydrogenase 1 (soluble) | |
| Apod | apolipoprotein D | −13.1097152 |
| Pcx | pyruvate carboxylase | 4.33910033 |
| Fabp4 | fatty acid binding protein | 29.2428857 |
| | 4, adipocyte | |
| Apoc1 | apolipoprotein C-1 | 3.77502085 |
| Adn | adipsin | 55.5907207 |
| Adipoq | adiponectin, C1Q and | 98.9725419 |
| | collagen domain containing | |
| Lipe | lipase, hormone sensitive | 6.80543408 |
| Lum | lumican | −3.94698561 |
| Fabp4 | fatty acid binding protein | 9.38585906 |
| | 4, adipocyte | |
| Fabp4 | fatty acid binding protein | 5.48498243 |
| | 4, adipocyte | |
| Clu | clusterin | −3.51558536 |
| Gpd1 | glycerol-3-phosphate | 12.443891 |
| | dehydrogenase 1 (soluble) | |
| Retn | resistin | 17.0625426 |
| Fabp4 | fatty acid binding protein | 24.1939835 |
| | 4, adipocyte | |

It was thus possible to show that only the cultivation of 3T3-L1 fibroblasts in the 3D matrix to be tested leads without external stimuli to an improved differentiation behaviour. Without using the array technology, this detection would not have been possible or would have been associated with much more intense effort. If the desire is then to test further materials with regard to this property, it is sufficient to use an array specifically oriented towards the cell type used and the relevant genes.

1. A method for producing a cell sensor system comprising:
a) cultivating a first group of cells of a specific type under standardised culture conditions as a control group,
b) cultivating a second group of cells of the specific type using different materials to be tested as a test group,
c) harvesting both groups of cells,
d) determining the gene activities of the cells of the control group and the cells of the test group,
e) comparing the gene activities of the test group with the control group,
f) identifying the genes for which there is a difference in the gene activities of the control group and the test group,
g) constructing a microarray using the genes identified as having different gene activities as a gene profile, thereby creating a microarray standard for the specific cell type, and
h) providing a third group of cells of the specific cell type as a cell sensor and the microarray standard, wherein the third group of cells and the microarray standard comprise the cell sensor system.

2. The method according to claim 1 wherein the materials to be tested are 3D matrix materials.

3. The method according to claim 2 wherein the microarray standard can serve as a standard for the specific cell type and the 3D matrix material used.

4. The method according to claim 3 wherein the 3D matrix material, the cells of the specific cell type and the microarray standard comprise the cell sensor system.

5. The method according to claim 4 wherein the 3D matrix material is polystyrene foamed with CO₂.

6. The method according to claim 4 wherein the gene activities to be determined are genes from a cell-specific genome.

7. The method according to claim 1 wherein whole genome microarrays are used to determine the gene activities.

8. The method according to claim 1 wherein the gene activities to be determined are gene activities of functional groups of genes selected from groups of genes having the functions of cell cycle, reactions on the cell nucleus, binding of the cell to surfaces, cell stress, formation of the typical cytoskeleton, signal transduction and apoptosis.

9. The method according to claim 1 wherein the gene activities are determined at the nucleic acid level or the protein level or both the nucleic acid level and the protein level.

10. The method according to claim 1 wherein the gene activities are determined using a microarray technique.

11. The method according to claim 10 wherein a DNA chip or a protein chip or both a DNA chip and a protein chip are used.

12. The method according to claim 1 wherein the difference in gene activities of the control group and the test group is by at least a factor of 2.

13. The method according to claim 1 wherein the difference in gene activities of the control group and the test group is by at least a factor of 3.

14. The method according to claim 1 wherein the specific cell type is 3T3-L1 fibroblasts.

15. The method according to claim 14 wherein the genes that are used for the microarray standard for the 3T3- L1 fibroblasts are selected from pyruvate carboxylase, stearoyl-coenzyme A desaturase 1, fatty acid binding protein 5, glycerol-3-phosphate dehydrogenase 1, apolipoprotein D, fatty acid binding protein 4, apolipoprotein C-1, adipsin, lipin 1, adinectin, lipase, angiotensinogen, resistin, CD36 antigen, fibromodulin, procollagen-lysine 2-oxoglutarate 5-dioxygenase 1, tissue inhibitor of metalloproteinase 4, lumican and clusterin.

16. A cell sensor system having multifunctional reactions comprising:
cells of a specific cell type, and
one or more microarrays having gene profiles created specifically for the cells of the specific cell type, according to the method of claim 1.

17. The cell sensor system according to claim 16 wherein the cell sensor system further comprises a 3D matrix material.

18. The cell sensor system according to claim 17 wherein the 3D matrix material is polystyrene foamed with CO₂.

19. The cell sensor system according to claim 16 wherein the one or more microarrays are a DNA array or a protein array or both a DNA array and a protein array.

20. The cell sensor system according to claim 16 wherein the cells are 3T3-L1 fibroblasts.

21. The cell sensor system according to claim 20 wherein the microarray uses a gene profile that comprises the genes for pyruvate carboxylase, stearoyl-coenzyme A desaturase 1, fatty acid binding protein 5, glycerol-3-phosphate dehydrogenase 1, apolipoprotein D, fatty acid binding protein 4, apolipoprotein C-1, adipsin, lipin 1, adinectin, lipase, angiotensinogen, resistin, CD36 antigen, fibromodulin, procollagen-lysine 2-oxoglutarate 5-dioxygenase 1, tissue inhibitor of metalloproteinase 4, lumican and clusterin.

22. A method for assessing materials for growing cells comprising:
a) cultivating a first group of cells of a specific type under standardised culture conditions as a control group),
b) cultivating a second group of cells of the specific type using different materials to be tested as a test group,
c) harvesting both groups of cells,
d) determining the gene activities of the cells of the control group and the cells of the test group,
e) comparing the gene activities of the test group with the control group,
f) identifying the genes for which there is a difference in the gene activities of the control group and the test group,
g) constructing a microarray using the genes identified as having different gene activities as a gene profile, thereby creating a microarray standard for the specific cell type,
h) cultivating a third group of cells of the specific cell type under standardised culture conditions as a second control group),
i) cultivating a fourth group of cells of the specific type using different materials to be tested as a second test group,
j) harvesting both groups of cells, and
k) determining the gene activities of the cells of the second control group and of the cells of the second test group using the microarray standard.

23. The method according to claim 22 wherein the materials to be tested are 3D matrix materials.

24. The method according to claim 22 wherein the cultivation of the second control group takes place on a 3D matrix material.

25. The method according to claim 23 wherein the 3D matrix material is polystyrene foamed with CO₂.

26. (canceled)

27. The method according to claim 22 wherein the cell sensor system according to claim 16 is used.

28. A method of assessing the quality of materials for growing cells comprising measuring one or more cell-biological reactions of the cells using the cell sensor system according to claim 16.

29. The method according to claim 28 wherein the cells are 3T3-L1 fibroblasts.

30. (canceled)

31. A kit for assessing materials for growing cells comprising the cell sensor system according to claim 16, a culture medium and a 3D matrix material.

32. A method for assessing materials for growing cells comprising:
a) cultivating a group of cells of a specific cell type under standardised culture conditions as a control group,
b) cultivating a group of cells of the specific type using different materials to be tested as a test group,
c) harvesting both groups of cells, and

d) determining the gene activities of the cells of the control group and of the cells of the test group using a microarray standard.

33. The method according to claim 32 wherein the cell sensor system according to claim 16 is used.
